(19) United States
(12) Patent Application Publication
(10) Pub. No.: US 2013/0344325 A1
(43) Pub. Date: Dec. 26, 2013

(54) REINFORCED INTERPHASE AND BONDED STRUCTURES THEREOF

(71) Applicants: Felix N. Nguyen, Tacoma, WA (US); Kenichi Yoshioka, Puyallup, WA (US); Alfred P. Haro, Spanaway, WA (US); Nobuyuki Arai, Iyo-gun (JP)

(72) Inventors: Felix N. Nguyen, Tacoma, WA (US); Kenichi Yoshioka, Puyallup, WA (US); Alfred P. Haro, Spanaway, WA (US); Nobuyuki Arai, Iyo-gun (JP)

(73) Assignee: TORAY INDUSTRIES, INC., Chuo-ku, Tokyo (JP)

(21) Appl. No.: 14/001,656

(22) PCT Filed: Feb. 24, 2012
(86) PCT No.: PCT/US12/26463

§ 371 Date: Aug. 26, 2013

Related U.S. Application Data
(60) Provisional application No. 61/446,126, filed on Feb. 24, 2011.
(60) Provisional application No. 61/585,930, filed on Jan. 12, 2012.

(51) Int. Cl. B32B 7/00

(52) U.S. Cl. CPC B32B 7/00
USPC 428/343; 428/375; 428/372; 427/385.5; 523/201

(57) ABSTRACT

Embodiments disclosed herein include a structure comprising an adherend and an adhesive composition, wherein the adhesive composition comprises at least a thermosetting resin, a curing agent, and an interfacial material, wherein the adherend is suitable for concentrating the interfacial material in an interfacial region between the adherend and the adhesive composition upon curing of the adhesive composition; a method of manufacturing a composite article by curing the adhesive composition and a reinforcing fiber; and a method of manufacturing an adhesive bonded joint comprising applying the adhesive composition to a surface of one of the two or of different kinds the adherend, and curing the adhesive composition to form an adhesive bond between the adherends. The resulting interfacial region, viz., the reinforced interphase, is reinforced by one or more layers of the interfacial material such that substantial improvements in bond strength and fracture toughness are observed.

### FIELD OF THE INVENTION

The present application provides an innovative bonded structure applicable to the fields of adhesive bonded joints and fiber reinforced polymer composites. The bonded structure includes an adherend and an adhesive composition comprising at least a thermosetting resin, a curing agent, a migrating agent, and an interfacial material. Upon curing of the adhesive composition, the interfacial material is concentrated in an interfacial region between the adherend and the adhesive composition, such that both tensile strength and fracture toughness of the bonded structure improve substantially.

### BACKGROUND OF THE INVENTION

Adherends are solid bodies regardless of size, shape, and porosity. When bonding two solid bodies together, selection of a good adhesive (initially is a liquid and solidified as cured) that is capable of chemically interacting with the adherend's surface upon curing is desirable. In addition, the bond has to be durable as subjected to environmental and/or hostile conditions. Bond strength or force per unit of interfacial area required to separate the (cured) adhesive and the adherend is a measure of adhesion. Maximum adhesion is obtained when a cohesive failure of either the adhesive or the adherend or both, as opposed to an adhesive failure between the adhesive and the adherend, are mainly observed.

To meet the above requirement, there cannot be voids at the interface between the adhesive and the adherend, i.e., there is sufficient molecular level contact between them upon curing. Often, this interface is considered as a volumetric region or an interphase. The interphase can extend from the adherend's surface to a few nanometers or up to several tens of micrometers, depending on the chemical composition of the adherend's surface, chemical interactions between the functional groups on the adherend's surface and of the bulk adhesive and from other chemical moieties migrating to the interface during curing. The interphase, therefore, has a very unique composition, and its properties are far different from those of the adhesive and the adherend.

High stress concentrations typically exist in the interphase due to the modulus mismatch between the adhesive and the adherend. The destructive action of these stress concentrations, which leads to an interfacial failure, may be aided by chemical embrittlement of the adhesive induced by the adherend, and local residual stress due to the thermal expansion coefficient difference. For these reasons, the interphase becomes the most highly stressed region, and is vulnerable to crack initiation, and subsequently leading to a catastrophic failure when loads are applied. Therefore, it makes sense to reduce these stress concentrations by tailoring a material having an intermediate modulus, or a ductile material between the adhesive and the adherend. The former involves lowering the modulus ratio of any two neighboring components, and is sometimes called a graded-modulus interphase. In the latter, local deformation capability is built into the interfacial region so that the stress concentrations are damped out, at least partially. In any case, the interfacial material is required to chemically interact with both the adherend and the adhesive upon cured, i.e., acts as an adhesion promoter.

One of the most important applications, where a structural adhesive is used to bond reinforcing adherends, is fiber reinforced polymer composites. An adhesion promoter material in this case is often called dsizing material or simply sizing or size. In other context it might be called a surface finish. Adhesion promoters are typically selected depending on applications, whether good, intermediate, or adequate adhesion is required. For glass fiber composites since the fiber's surface has many actively binding sites, silane coupling agents are most widely used, and can readily be applied to the surface. The silanes are specifically selected so that their organofunctional groups can chemically interact with the polymer matrix, thus adhesion is improved. For other fiber surfaces such as carbonaceous material (e.g., carbon fibers, carbon nanofibers, carbon nanotubes or CNTs, CNT fibers), other inorganic fibers and organic fibers (e.g., Kevlar®, Spectra®), the surface might need to be oxidized by a method such as plasma, corona discharge, or wet electro-chemical treatments to increase the oxygen functional group density through which a silane or a simple sizing composition, which is compatible and/or reactive sizing material to the polymer, can be anchored in a solvent assisted coating process. Examples of such sizing composition and process are described in U.S. Pat. No. 5,298,576 (Sumida et al., Toray Industries, Inc., 1994) and U.S. Pat. No. 5,589,055 (Kobayashi et al., Toray Industries, Inc., 1996).

Conventional adhesion promoter materials can be tailored to dramatically promote adhesion, or effectively provide a path through which applied stresses can be transferred from the polymer matrix to the fibers. However, they ultimately fail to resolve the discontinuities in the bulk matrix due to either insufficient strength/ toughness of the resulting interphase, or the difficulties in creating a thick interphase. While the former relies on an innovative sizing composition, the latter is restricted by either fiber coating processes or fiber handling purposes for subsequent fiber/matrix fabrication processes, or both.

Conventionally, inadequate adhesion might allow crack energy to be dissipated along the fiber/matrix interface, but at the great expense of stress transfer capability from the adhesive through the interphase to the fibers. Strong adhesion, on the other hand, often results in an increase in interfacial matrix embrittlement, allowing cracks to initiate in these regions, and propagate into the resin-rich areas. In addition, crack energy at a fiber's broken end could not be relieved along the fiber/matrix interface, and therefore, diverted into neighboring fibers by essentially breaking them. To resolve this, one possible approach is to toughen the adhesive to increase fracture toughness of the composite substantially, and that might help blunt the crack tip as it the crack propagates through the resin-rich areas. However, this strategy could not resolve the interfacial matrix imbrittlement, and therefore, tensile or tensile related properties typically remain unchanged or decreases. The other approach is to directly reinforce the interphase by an unconventional sizing formulation. Yet, this reinforced interphase requires a strong and toughened interfacial material that is formed a thick interphase with the resin after cured so that both stress relief and stress transfer can occur at this interphase, maximizing fracture toughness and tensile/tensile-related properties while minimizing penalties of other properties. Nevertheless, complications often arise to meet the challenge.

To increase fracture toughness of a fiber composite, specifically mode I interlaminar fracture toughness G_{IC}, a conventional approach is to toughen the matrix with a submicrometer-sized or smaller soft polymeric toughening agent. Upon cured of the composite the toughening agent is most likely spatially found inside the fiber bed/matrix region, called the intraply as opposed to the resin-rich region between two plies, called the interply. Uniform distribution of the toughening agent is often expected to maximize G_{IC}. Examples of such resin compositions include, U.S. Pat. No. 6,063,839 (Oosedo et al., Toray Industries, Inc., 2000), EP2256163A1 (Kamae et al., Toray Industries, Inc., 2009) with rubbery soft core/hard shell particles, U.S. Pat. No. 6,878,776B1 (Pascault et al., Cray Valley S.A., 2005) for reactive polymeric particles, U.S. Pat. No. 6,894,113B2 (Court el al., Atofina, 2005) for block copolymers and US20100280151A1 (Nguyen et al., Toray Industries Inc., 2010) for reactive hard core/soft shell particles. For these cases, since a soft material was incorporated in the resin in a large amount either by weight or volume, G_{IC} increased substantially, and potentially effectively dissipate the crack energy from the fiber's broken ends. Nevertheless, since the resin's modulus was substantially reduced, except in the case of US20100280151A1, a substantial reduction in stress transferring capability of the matrix to the fibers can be rationalized. Therefore, tensile and tensile-related properties at most remain unchanged or at least reduced to a significant extent. In addition, there would be a large penalty of compressive properties of the composite reflected by a substantial reduction in the resin's modulus.

Many attempts to design a reinforced interphase have been found up to date. For example, US20080213498A1 (Drzal et al., Michigan State University, 2008) showed that they could successfully coat the carbon fibers with up to 3wt % of graphite nanoplatelets and about 40% improvement in adhesion measured by interlaminar shear strength (ILSS), and correspondingly about 35% increase in flexural strength of the composite. No fracture toughness was discussed; however, it was expected that a significant drop could be resulted for the rigid and brittle (untoughened) interphase, hence low fracture toughness could be observed. Other carbonaceous nanomaterials such as carbon nanotubes were also introduced to a fiber's surface directly either by an electrophoresis or chemical vapor deposition (CVD) or a similar process known to one skilled art. For example, Bekyarova et al. (Langmuir 23, 3970, 2007) introduced a reinforced interphase using carbon nanotube coated woven carbon fiber fabric. Adhesion measured by ILSS was increased but tensile strength remained the same. No fracture toughness data was provided. WO2007130979A2 (Kruckenberg ct al., Rohr, Inc. and Goodrich Corporation, 2007) has claimed carbon fibers with such carbonaceous materials and the alike. WO2010096543A2 (Kissounko et al., University of Delaware/Arkema Inc., 2010) showed that when glass fiber was sized in a solution mixture of a combination of two silanes coupling agents and a hydroxyl functionalized rubbery polymer or a block copolymer, the adhesion (interfacial shear stress or IFSS) measured by microdroplet test of single fiber/matrix composite systems was not increased but the toughness (area under stress/strain curve as oppose to fracture toughness, a measure of resistance to crack growth) increased significantly. This indicates that the resulting interphase was not stiff enough to transfer stress, and yet, this toughened interphase could absorb energy. On the other hand, as silica nanoparticles were used instead of rubbery polymers, significant increase in IFSS was observed as the stiffness of the interphase was regained; yet, toughness was reduced. As a result, a sizing composition comprising organic and inorganic components was proposed to achieve simultaneous increase in adhesion and toughness. Above all, no composite data on fracture toughness and tensile and tensile-related properties was presented to confirm the observed properties of single fiber/matrix composites. In addition, the rubbery polymer component in the sizing formulation might not give a consistent composite material as the polymer's morphology in the cured composite might depend on curing conditions and the amount of the polymer. Leonard et al. (Journal of Adhesion Science and Technology 23, 2031, 2009) introduced a particle coating process in which the amine-reactive core-shell particles were dispersed in water, and glass fibers were dipped into the solution. Adhesion measured by fiber fragmentation test showed an increase for single/ as well as bundle fiber/poly vinyl butyral (PVB) composites over the system where the fibers were treated with a conventional aminosilane system. Single tow fiber/PVB composites showed an increase in tensile strength and toughness as well. No fracture toughness, however, was measured.

All the above sizing applications and other known applications to date involve a direct method in either a wet chemistry (i.e., involve a solvent) or dry chemistry (e.g., CVD, powder coating) process to incorporate a sizing formulation to the fiber's surface. Such processes typically have some degree of complication depending on the sizing composition, but might not give an uniform coating, and more importantly the result coating layer, since thicker than the conventional, potentially renders difficulties in fiber handling (i.e., fiber spreading) during an impregnation process in which a resin matrix impregnates a bed of dry fibers, as well as keeping them in a storage area, i.e., shorten their shelf life. In addition, fiber handling and shelf life issues become more serious as the required interfacial thickness increases. More importantly to date though a reinforced interphase was commonly thought of or sought, a creation of one has been proven very challenging with the conventional processes, and thus effectiveness of this interphase in composite materials was not understood, often overlooked or ignored.

Similar difficulties have been observed in adhesive bonded joints, and the quest to create a reinforced interphase has been sought vigorously. For example, Ramrus et al. (Colloids Surfaces A 273, 84, 2006 and Journal of Adhesion Science and Technology 20, 1615, 2006) demonstrated that stick-slip crack growth in adhesion promotion/demotion silane patterned aluminum surface/PVB system was an important mechanism to relieve interfacial stress concentration, thus improve adhesion significantly over the unpatterned surface which was coated with adhesion promotion silane only. Unfortunately, when an epoxy was used instead, because of its brittleness, no adhesion for the patterned case was improved as bonding strength came from the weak cohesive failure of the epoxy on top of an adhesive failure. Another example of a toughened interphase design was performed by Dodiuk et al. with hyperbranched (HB) and dendrimeric polyamidoamine (PAMAM) polymers were introduced by (Composite Interfaces 11, 453, 2004 and Journal of Adhesion Science and Technology 18, 301, 2004). This interfacial material composition, when applied to aluminum, magnesium, and plastics (PEI Utem 1000) surfaces, allowed a substantial increase in bonding strength to an epoxy or polyurethane. However, as the amount of PAMAM increased more than lwt %, adhesion was decreased due to plasticization. Above all, the material was very expensive. Another example was demonstrated by Liu et al. applying Boegel®, a patented silane-crosslinked zirconium gel network developed by The Boeing Company, to an aluminum surface for bonding with an epoxy system (Journal of Adhesion 82, 487, 2006 and Journal of Adhesion Science and Technology 20, 277, 2006). Since cohesive failure in the brittle gel network (the interphase) was observed, the anticipated adhesion improvement was not achieved. US 20080251203A1 (Lutz et al., Dow Chemical, 2008) and EP 2135909 (Malone, Hankel Corp., 2009) formulated an adhesive coating formulation with rubbery materials such as core-shell rubber particles. Adhesion was improved, and cohesive failures were occasionally observed; however, because the strength and modulus of the adhesive was not sufficient as a large amount of rubbery materials were present, and dispersed throughout the bond line, bond strengths were reflected from the adhesive's strength, and therefore were not optimum.

### SUMMARY OF THE INVENTION

An embodiment herein introduces a breakthrough in designing a strong, toughened, thick reinforced interphase that is formed between an adherend and an adhesive composition upon curing of the adhesive composition, comprising at least a thermosetting resin, a curing agent, and an interfacial material, wherein the adherend has a suitable surface energy for concentrating the interfacial material in an interfacial region between the adherend and the adhesive composition, to provide an ultimate solution to the aforementioned difficulties in designing high-performance bonded structures. The adhesive composition further comprises a migrating agent, an accelerator, a toughener and a filler.

An embodiment relates to a fiber reinforced polymer composition comprises a reinforcing fiber and an adhesive composition, wherein the adhesive composition comprises at least a thermosetting resin, a curing agent and an interfacial material, wherein the reinforcing fiber has a surface energy suitable for concentrating the interfacial material in an interfacial region between the reinforcing fiber and the adhesive composition upon curing of the adhesive composition. The adhesive composition further comprises a migrating agent, a toughener, a filler, and an interlayer toughener.

Embodiments relate to a structure comprising an adherend and an adhesive composition, wherein the adhesive composition comprises at least a thermosetting resin, a curing agent, an interfacial material and a migrating agent, wherein the adherend has a surface energy suitable for concentrating the interfacial material in an interfacial region between the adherend and the resin composition upon curing of the adhesive composition, wherein the interfacial region comprises at least one layer of the interfacial material, wherein the layer comprises a higher concentration of the interfacial material than the bulk adhesive composition. The interfacial material upon curing of the adhesive composition could be substantially concentrated in the interfacial region from the adherend's surface to a radial distance of about 100 micrometers (100 μm). The adherend comprises reinforcing fibers, carbonaceous substrates, metal substrates, metal alloy substrates, coated metal substrates, alloy substrates, wood substrates, oxide substrates, plastic substrates, composite substrates, or combinations thereof.

An embodiment relates to a fiber reinforced polymer composition comprises a reinforcing fiber and an adhesive composition, wherein the adhesive composition comprising at least a thermosetting resin, a curing agent, a migrating agent, and an interfacial material, wherein the reinforcing fiber has a surface energy suitable for concentrating the interfacial material in an interfacial region between the reinforcing fiber and the adhesive composition upon curing of the fiber reinforced polymer composition, wherein the interfacial region comprises at least one layer of the interfacial material, wherein the interfacial material is more concentrated in the interfacial region than the bulk adhesive composition. The interfacial material upon curing of the fiber reinforced polymer could be substantially located in a radial region from the fiber's surface to a distance of about one fiber radius. The interfacial material comprises a polymer, a linear polymer, a branched polymer, a hyperbranched polymer, dendrimer, a copolymer, a block copolymer, an inorganic material, a metal, an oxide, carbonaceous material, organic-inorganic hybrid material, polymer grafted inorganic material, organofunctionalized inorganic material, combinations thereof An amount of the interfacial material could be between about 0.5 to about 25 weight parts per 100 weight parts of the thermosetting resin. The migrating agent comprises a polymer, a thermoplastic resin, or a thermosetting resin. The thermoplastic resin comprises a polyvinyl formal, a polyamide, a polycarbonate, a polyacetal, a polyvinylacetal, a polyphenyleneoxide, a polyphenylenesulfide, a polyarylate, a polyester, a polyamideimide, a polyimide, a polyetherimide, a polyimide having phenyltrimethylindane structure, a polysulfone, a polyethersulfone, a polyetherketone, a polyetheretherketone, a polyaramid, a polyethernitrile, a polybenzimidazole, their derivatives, or combinations thereof An amount of the migrating agent could be between about 1 to about 30 weight parts per 100 weight parts of the thermosetting resin. A ratio of the migrating agent to the interfacial material could be about 0.1 to about 30.

Another embodiment relates a prepreg comprising a fiber reinforced polymer composition, wherein the fiber reinforced polymer composition comprises a reinforcing fiber and an adhesive composition, wherein the adhesive composition comprising at least a thermosetting resin, a curing agent, a migrating agent, and an interfacial material, wherein the reinforcing fiber has a surface energy suitable for concentrating the interfacial material in an interfacial region between the upon curing of the fiber reinforced polymer composition, wherein the interfacial region comprises at least one layer of the interfacial material, wherein the interfacial material is more concentrated in the interfacial region than the bulk adhesive composition.

Another embodiment relates a manufacturing method comprises manufacturing a composite article from a fiber reinforced polymer composition, wherein the fiber reinforced polymer composition comprises a reinforcing fiber and an adhesive composition, wherein the adhesive composition comprising at least a thermosetting resin, a curing agent, a migrating agent, and an interfacial material, wherein the reinforcing fiber has a surface energy suitable for concentrating the interfacial material in an interfacial region between the upon curing of the fiber reinforced polymer composition, wherein the interfacial region comprises at least one layer of the interfacial material, wherein the interfacial material is more concentrated in the interfacial region than the bulk adhesive composition.

Another embodiment relates an adhesive bonded joint structure comprises an adherend and an adhesive composition, wherein the adherend comprises reinforcing fiber, carbonaceous substrate, metal substrate, metal alloy substrate, coated metal substrate, alloy, wood, oxide substrate, plastic substrate, or composite substrate, wherein upon cured one or more the components of the adhesive component is more concentrated in the vicinity of the adherends than further away.

Another embodiment relates a method comprising applying an adhesive composition to a surface of one of the two or more of different kinds adherends and curing the adhesive composition to form an adhesive bond between the adherends, wherein the adhesive composition comprises at least a thermosetting resin, a curing agent, a migrating agent, and an interfacial material, wherein the adherends comprising reinforcing fibers, carbonaceous substrates, metal substrates, metal alloy substrates, coated metal substrates, alloys, woods, oxide substrates, plastic substrates, or composite substrates, wherein the interfacial material is more concentrated in the vicinity of the adherends than further away.

### BRIEF DESCRIPTIONS OF THE DRAWINGS

FIG. 1 shows a schematic 90° cross-section view of a bonded structure. The interfacial material insoluble or partially soluble is concentrated in the vicinity of the adherends. An interfacial region or interphase is approximately bound from the adherend surface to the dashed line, where the concentration of the interfacial material is no longer substantially higher than the bulk adhesive resin composition. One layer of the interfacial material is also illustrated.

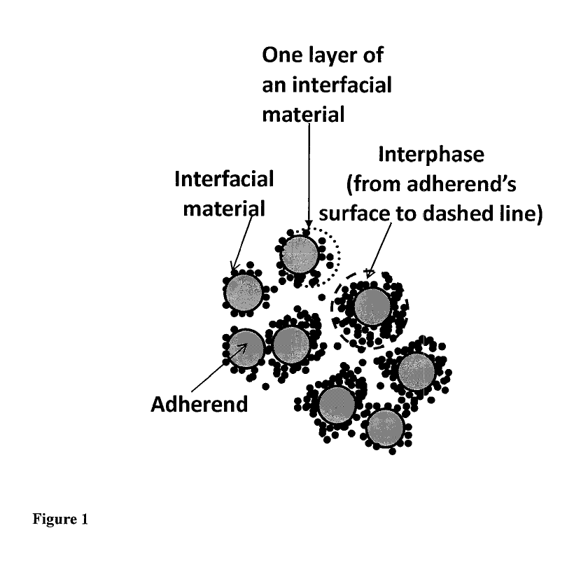

FIG. 2 shows a schematic 0° cross-section view of the cured bonded structure. The interfacial material insoluble or partially soluble is concentrated on the adherend's surface with the (cured) adhesive. The figure illustrates a case of good particle migration.

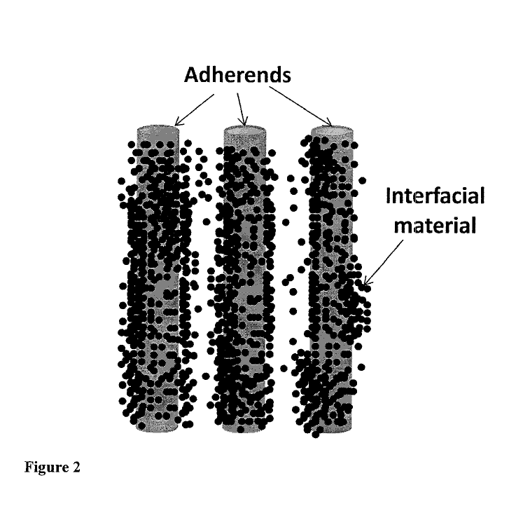

### DETAILED DESCRIPTION OF THE INVENTION

### Thermosetting Resin and Curing Agent/Optional Accelerator

An embodiment relates to structure comprising at least an adherend and an adhesive composition, wherein the adhesive composition comprises at least a thermosetting resin, a curing agent, and an interfacial material, wherein the adherend has a surface energy suitable for concentrating the interfacial material in an interfacial region between the adherend and the adhesive composition, wherein the interfacial region comprises at least a layer of the interfacial material. The adhesive composition can further comprise an accelerator, a migrating agent, a toughening agent, a filler, and a interlayer tougher.

The thermosetting resin defined as any resin which can be cured with a curing agent by means of an external energy such as heat, light, electromagnetic waves such as microwaves, UV, electron beam, or other suitable methods to form a three dimensional crosslink network. A curing agent is defined as any compound having at least an active group which reacts with the resin. A curing accelerator can be used to accelerate cross-linking reactions between the resin and curing agent.

The thermosetting resin is selected from, but not limited, epoxy resin, cyanate ester resin, maleimide resin, bismaleimide-triazine resin, phenolic resin, resorcinolic resin, unsaturated polyester resin, diallylphthalate resin, urea resin, melamine resin, benzoxazine resin, polyurethane, and their mixtures thereof.

Of the above thermosetting resins, epoxy resins.could be used, including di-functional or higher epoxy resins. These epoxies are prepared from precursors such as amines (e.g., tetraglycidyldiaminodiphenylmethane, triglycidyl-p-aminophenol, triglycidyl-m-aminophenol and triglycidylaminocresol and their isomers), phenols (e.g., bisphenol A epoxy resins, bisphenol F epoxy resins, bisphenol S epoxy resins, phenol-novolack epoxy resins, cresol-novolac epoxy resins and resorcinol epoxy resins), and compounds having a carbon-carbon double bond (e.g., alicyclic epoxy resins). It should be noted that the epoxy resins are not restricted to the examples above. Halogenated epoxy resins prepared by halogenating these epoxy resins can also be used. Furthermore, mixtures of two or more of these epoxy resins, and monoepoxy compounds such as glycidylaniline can be employed in the formulation of the thermosetting resin matrix.

Examples of suitable curing agents for epoxy resins include, but not limitedto, polyamides, dicyandiamide, amidoamines, aromatic diamines (e.g., diaminodiphenylmethane, diaminodiphenylsulfone), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophoron diamine), imidazole derivatives, tetramethylguanidine, carboxylic acid anhydrides (e.g., methylhexahydrophthalic anhydride, carboxylic acid hydrazides (e.g., adipic acid hydrazide), phenol-novolac resins and cresol-novolac resins, carboxylic acid amides, polyphenol compounds, polysulfide and mercaptans, and Lewis acid and base (e.g., boron trifluoride ethylamine, tris-(diethylaminomethyl)phenol).

Depending on the desired properties of a cured bonded structure such as a fiber reinforced epoxy composite, a suitable curing agent is selected from the above list. For examples, if dicyandiamide is used, it will provide the product good elevated-temperature properties, good chemical resistance, and good combination of tensile and peel strength. Aromatic diamines, on the other hand, will give moderate heat and chemical resistance and high modulus. Aminobenzoates will provide excellent tensile elongation though they have inferior heat resistance compared to aromatic diamines. Acid anhydrides will provide the resin matrix low viscosity and excellent workability, and subsequently, high heat resistance after cured. Phenol-novolac resins or cresol-novolac resins provide moisture resistance due to the formation of ether bonds, which have excellent resistance to hydrolysis. Above all, a curing agent having two or more aromatic rings such as 4,4′-diaminodiphenyl sulfone (DDS) will provide high heat resistance, chemical resistance and high modulus could be a curing agent for epoxy resins.

Examples of suitable accelerator/curing agent pairs for epoxy resins are borontrifluoride piperidine, p-t-butylcatechol, or a sulfonate compound for aromatic amine such as DDS, urea or imidazole derivatives for dicyandiamide, and tertiary amines or imidazole derivatives for carboxylic anhydride or polyphenol compound. If an urea derivative is used, urea derivatives may be compounds obtained by reacting with secondary amines with isocyanates. Such accelerators are selected from the group of 3-phenyl-1,1-dimethylurea, 3-(3,4-dichlorophenyl)-1,1-dimethylurea (DCMU) and 2,4-toluene bis-dimethyl urea. High heat resistance and water resistance of the cured material are achieved, though it is cured at a relatively low temperature.

### Toughening Agent and Filler

Polymeric and/or inorganic toughening agent can be used in addition to the present adhesive composition to further enhance fracture toughness of the resin. The toughening agent is could be uniformly distributed in the cured bonded structure. The particles could be less than 5 micron in diameter, or even less than 1 micron. The shortest dimension of the particles could be less than 300 nm. Such toughening agents include, but not limited to, branched polymer, hyperbranched polymer, dendrimer, block copolymer, core-shell rubber particles, core-shell (dendrimer) particles, hard core-soft shell particles, soft core-hard shell particles, oxides or inorganic materials with or without surface modification such as clay, polyhedral oligomeric silsesquioxane (POSS), carbonaceous materials (e.g., carbon black, carbon nanotube, carbon nanofiber, fullerene), ceramic and silicon carbide.

If desired, especially for adhesive bonded joints, a filler, rheological modifier and/or pigment could be present in the adhesive composition. These can perform several functions, such as (1) modifying the rheology of the adhesive in a desirable way, (2) reducing overall cost per unit weight, (3) absorbing moisture or oils from the adhesive or from a substrate to which it is applied, and/or (4) promoting cohesive failure in the (cured) adhesive, rather than adhesive failure at the interface between the adhesive and the adherends. Examples of these materials include calcium carbonate, calcium oxide, talc, coal tar, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel or metal powders such as aluminum powder or iron powder. Among these, calcium carbonate, talc, calcium oxide, fumed silica and wollastonite could be used, either singly or in some combination, as these often promote the desired cohesive failure mode.

### Migrating Agent and Interfacial Material

The migrating agent in the present adhesive composition is any material inducing one or more components in the adhesive composition to be more concentrated in an interfacial region between the adherend and the adhesive composition upon curing of the adhesive composition. This phenomenon is hereafter referred to as a migration process of the interfacial material to the vicinity of the adherend, which hereafter refers to as particle migration. Any material found more concentrated in a vicinity of the adherend than further away from the adherend or present in the interfacial region or the interphase between the adherend's surface to a definite distance into the cured adhesive composition constitutes an interfacial material in the present adhesive composition. Note that one interfacial material can play the role of a migrating agent for another interfacial agent if it can cause the second interfacial material to have a higher concentration in a vicinity of the adherend than further way upon curing of the adhesive composition.

The migrating agent present in the adhesive composition could be a, thermoplastic polymer. Typically, the thermoplastic additives are selected to modify viscosity of the thermosetting resin for processing purposes, and/or enhance its toughness, and yet could affect the distribution of the interfacial material in the adhesive composition to some extent. The thermoplastic additives, when present, may be employed in any amount up to 50 parts by weight per 100 parts of the thermosetting resin (50phr), or up to 35 phr for ease of processing.

One could use, but not limited to, the following thermoplastic materials such as polyvinyl formal, polyamide, polycarbonate, polyacetal, polyphenyleneoxide, poly phcnylene sulfide, polyarylate, polyester, polyamideimide, polyimide, polyetherimide, polyimide having phenyltrimethylindane structure, polysulfone, polyethersulfone, polyetherketone, polyetheretherketone, polyaramid, polyethernitrile, polybenzimidazole, their deviratives and their mixtures thereof.

One could use aromatic thermoplastic additives which do not impair high thermal resistance and high elastic modulus of the resin. The selected thermoplastic additive could be soluble in the resin to a large extent to form a homogeneous mixture. The thermoplastic additives could be compounds having aromatic skeleton from the following group consisting of a polysulfone, a polyethersulfone, a polyarnide, a polyamideimide, a polyimide, a polyetherimide, a polyetherketone, a polyetheretherketone, and polyvinyl formal, their derivatives, the alike or similar, and mixtures thereof.

The interfacial material in the present adhesive composition is a material or a mixture of materials that might not be as compatible with the migrating agent as with the adherend's surface chemistry and therefore, could stay concentrated in an interfacial region between the adherend and the adhesive composition, when they both are present in the adhesive composition to at some ratio. Compatibility refers to chemically like molecules, or chemically alike molecules, or molecules whose chemical makeup comprising similar atoms or structure, or molecules that like one another and comfortable to be in the proximity of one another and possibly chemically interact with one another. Compatibility implies solubility and/or reactivity of one component to another component. “Not compatible/ incompatible” or “does not like” refers to a phenomenon that when the migrating agent, when presents at a certain amount in the adhesive composition, causes the interfacial material, which would have been uniformly distributed in the adhesive composition after cured, to be not uniformly distributed to some extent. When viscosity of the adhesive composition is adequately low, a uniform distribution of the interfacial material in the adhesive composition might not be necessary to promote particle migration onto the adherend's surface. As viscosity of the adhesive composition increases to some extent, a uniform distribution of the interfacial material in the adhesive composition could help improve particle migration onto the adherend's surface.

The interfacial material could comprise a polymer, selected from but not limited to linear polymer, branched polymer, hyperbranched polymer, dendrimer, copolymer or block copolymer. Derivatives of such polymers comprising preformed polymeric particles (e.g., core-shell particle, soft core-hard shell particle, hard core-soft shell particle), polymer grafted inorganic material (e.g., a metal, an oxide, carbonaceous material), and organofunctionalized inorganic material could also be used. The interfacial material is being insoluble or partially soluble in the adhesive composition after cured. The interfacial material in the adhesive composition could be up to 35 phr, or between about 1 to about 25 phr.

In another embodiment, an interfacial material could he a toughening agent or a mixture of toughening agents containing one or more components incompatible with the migrating agent. Such toughening agents include, but not limited to, an elastomer, a branched polymer, a hyperbranched polymer, a dendrimer, a rubbery polymer, a rubbery copolymer, block copolymer, core-shell particles, oxides or inorganic materials such as clay, polyhedral oligomeric silsesquioxane (POSS), carbonaceous materials (e.g., carbon black, carbon nanotube, carbon nanofiber, fullerene), ceramic and silicon carbide, with or without surface modification. Examples of block copolymers whose composition as described in U.S. Pat. No. 6,894,113 (Court et al., Atofina, 2005) and include “Nanostrength®” SBM (polystyrene-polybutadiene-polymethacrylate), and AMA (polymethacrylate-polybutylacrylate-polymethacrylate), both produced by Arkema. Other block copolymers include Fortegra® and amphiphilic block copolymer described in U.S. Pat. No. 7,820,760B2 by Dow Chemical. Examples of known core-shell particles include core-shell (dendrimer) particles whose compositions as described in US20100280151A1 (Nguyen et al., Toray Industries, Inc., 2010) for an amine branched polymer as shell grafted a core polymer polymerized from a polymerizable monomers containing unsaturated carbon-caarbon bonds, core-shell rubber particles whose compositions described in EP 1632533A1 and EP 2123711A1 by Kaneka Corporation, and “KaneAce MX” product line of such particle/epoxy blends whose particles have a polymeric core polymerized from polymerizable monomers such as butadiene, styrene, other unsaturated carbon-carbon bond monomer, or their combinations, and a polymeric shell compatible with the epoxy, typically polymethylmethacrylate, polyglycidylmethacrylate, polyacrylonitrile or the alike and similar . “JSR SX” series of carboxylated polystyrene/polydivinylbenzene produced by JSR Corporation. “Kureha Paraloid” EXL-2655 (produced by Kureha Chemical Industry Co., Ltd.), which is a butadiene alkyl methacrylate styrene copolymer; “Stafiloid” AC-3355 and TR-2122 (both produced by Takeda Chemical Industries, Ltd.), each of which are acrylate methacrylate copolymers; “PARALOID” EXL-2611 and EXL-3387 (both produced by Rohm & Haas), each of which are butyl acrylate methyl methacrylate copolymers. Examples of known oxide particles include Nanopox® produced by nanoresins AG. This is a master blend of functionalized nanosilica particles and an epoxy.

The toughening agent to be used as an interfacial material could be rubbery material such as core-shell particles which can be found in Kane Ace MX product line by Kaneka Corporation (e.g., MX416, MX125, MX156) or a material having a shell composition or a surface chemistry similar to Kane Ace MX materials or a material having a surface chemistry compatible with the adherend's surface chemistry, which allows the material to migrate to the vicinity of the adherend and has a higher concentration than the bulk adhesive composition. These core-shell particles are typically well dispersed in an epoxy base material at a typical loading of 25% and ready to be used in the adhesive composition for high performance bonds to the adherends.

When both migrating agent and interfacial material are present in the adhesive composition, a ratio of the migrating agent to the interfacial material could be about 0.1 to about 30, or about 0.1 to about 20.

### Interlayer Tougheners

Another embodiment, especially for fiber reinforced polymer composites, is to use the present toughening agent with other interlayer toughening materials to maximize damage tolerance and resistance of the composite materials. In the embodiments herein, the materials could be thermoplastics, elastomers, or combinations of an elastomer and a thermoplastic, or combinations of an elastomer and an inorganic such as glass. The size of interlayer tougheners could be no more than 100 μm, or 10-50 μm, to keep them in the interlayer after curing. Such particles are generally employed in amounts of up to about 30%, or up to about 15% by weight (based upon the weight of total resin content in the composite composition).

An example of the thermoplastic materials includes polyamides. Known polyamide particles include SP-500, produced by Toray Industries, Inc., “Orgasole” produced by Atochem, and Grilamid TR-55 produced by EMS-Grivory, nylon-6, nylon-12, nylon 6/12, nylon 6/6, and Trogamid CX by Evonik.

Another embodiment relates to have the migrating agent concentrated outside the fiber bed comprising of fiber fabric, mat, reform that is then infiltrated by the adhesive composition. This configuration allows the migrating agent to be an interlayer toughener for impact and damage resistances, simultaneously, driving the interfacial material away from the interply and into the intralayer, allowing it to concentrate on the fiber's surface. Thermoplastic particles with the size less than 50um could be used. Examples of such thermoplastic materials include but not limited to a polysulfone, a polyethersulfone, a polyamide, a polyamideimide, a polyimide, a polyetherimide, a polyetherketone, a polyetheretherketone, and polyvinyl formal, their derivatives, the alike or similar, and the mixtures thereof.

### Adherends

The adherends used are solid bodies regardless of size, shape, and porosity. They can be, but not limited to, reinforcing fibers, carbonaceous substrates (e.g., carbon nanotube, carbon particle, carbon nanofiber, carbon nanotube fiber), metal substrates (e.g., aluminum, steel, titanium, magnesium, lithium nickel, brass, and their alloys), coated metal substrates, wood substrates, oxide substrates (e.g., glass, alumina, titania), plastic substrates (i.e., molded thermoplastic material such as polymethyl methacrylate, polycarbonate, polyethylene, polyphenyl sulfide, or molded thermosetting material such as epoxy, polyurethane), or composite substrates (i.e., filler reinforced polymer composite with fillers being silica, fiber, clay, metal, oxide, carbonaceous material, and the polymer being a thermoplastic or a thermoset).

The adherend is prepared for bonding with the present adhesive composition by a process in which the surface chemistry is changed or modified to enhance its bonding capabilities. Surface chemistry of a surface is typically accessed by surface energy. Typically surface energy is a sum of two major components, a dispersive (nonpolar, LW) component and an acid/base (polar, AB) component. A brief description of surface energy can be found from Sun and Berg's publications (Advances in Colloid and Interface Science 105 (2003) 151-175 and Journal of Chromatography A, 969 (2002) 59-72) in the paragraph below.

The surface free energy of solids is an important property in a wide range of situations and applications. It plays an important role in the formation of solid particles either by comminution (cutting, crushing, grinding, etc.) or by their condensation from solutions or gas mixtures by nucleation and growth. It governs their wettability and coatability by liquids and their dispersibility as fine particles in liquids. It is important in their sinterability and their interaction with adhesives. It controls their propensity to adsorb species from adjacent fluid phases and influences their catalytic activity.

Additionally, the surface is roughened to further enhance bond strength. These roughening method often increase oxygen functional groups of the surface as well. Examples of such methods include anodizing for metal and alloy substrates, corona discharge for plastic surfaces, plasma, UV treatment, plasma assisted microwave treatment, and wet chemical-electrical oxidization for carbon fibers and other fibers. Additionally, the treated or modified surfaces could be grafted with an organic material or organic/inorganic material such as a silane coupling agent or a silane network or a polymer composition compatible and/ or chemically reactive to the resin matrix to improve bonding strengths or ease of processing of intennediate products or both. Such treatments provide the surface with either acidic or basic characteristics, allowing the surface to attract the interfacial material from the adhesive composition and concentrating it in the vicinity of the surface during curing, as it is more compatibly stay close to the surface than present in the adhesive composition, where the migrating agent exists. In such cases, it is said that the adherend has a suitable surface energy for concentrating the interfacial material in an interfacial region between the adherend and the adhesive composition.

Acidic or basic properties of a surface could be determined from any currently available methods such as acid-base titration, infrared (IR) spectroscopy techniques, inverse gas chromatography (IGC), and x-ray photoelectron microscopy (XPS), or similar and the alike. IGC can be used to rank acid/base properties among solid surfaces, which was described in Sun and Berg's publications. A brief summary is described in the paragraph below.

Vapor of known liquid probes are carried into a tube packed with solid materials of unknown surface energy and interacting with the surface. Based on the time that a gas traverses through the tube, the free energy of adsorption can be determined. Hence, the dispersive component of surface energy can be determined from a series of alkane probes, whereas the relative value of acid/base component of surface energy can be ranked among interrogated surfaces using 2-5 acid/base probes by comparing the ratio of the acid to the base constant of each surface.

Proper selections for a combination of an adherend with specific acid-base properties and surface energy, a migrating agent, and interfacial material may be required to form the desired reinforced interphase.

In one embodiment the adherend is a reinforcing fiber. The fiber used can be, but not limited to, any of the following fibers and their combinations: carbon fibers, organic fibers such as aramide fibers, silicon carbide fibers, metal fibers (e.g., alumina fibers), boron fibers, tungsten carbide fibers, glass fibers, and natural/bio fibers. Among these fibers, carbon fibers, especially graphite fibers, may be used. Carbon fibers with a strength of 2000 MPa or higher, an elongation of 0.5% or higher, and modulus of 200 GPa or higher may be used.

The morphology and location of the reinforcing fibers used are not specifically defined. Any of morphologies and spatial arrangements of fibers such as long fibers in a direction, chopped fibers in random orientation, single tow, narrow tow, woven fabrics, mats, knitted fabrics, and braids can be employed. For applications where especially high specific strength and specific modulus are required, a composite structure where reinforcing fibers are arranged in a single direction could be used, but cloth (fabric) structures, which are easily handled, may be used.

### Fabrication Techniques for a Bonded Structure

An adhesive composition can be applied to the aforementioned adherends by any convenient and currently known techniques. For the case of adhesive bonded joints, it can be applied cold or be applied warm if desired. For examples, the adhesive composition can be applied using mechanical application methods such as a caulking gun, or any other manual application means, it can be applied using a swirl technique using an apparatus well known to one skilled in the art such as pumps, control systems, dosing gun assemblies, remote dosing devices and application guns, it can also be applied using a streaming process. Generally, the adhesive composition is applied to one or both substrates. The substrates are contacted such that the adhesive is located between the substrates to be bonded together.

After application, the structural adhesive is cured by heating to a temperature at which the curing agent initiates cure of the adhesive composition. Generally, this temperature is about 80° C. or above, or about 100° C. or above. The temperature could be about 220° C. or less, or about 180° C. or less. One-step cure cycle or multiple-step cure cycle in that each step is performed at a certain temperature for a period of time could be used to reach a cure temperature of about 220° C. or even 180° C. or less. Note that other curing method using an energy source other than thermal, such as electron beam, conduction method, microwave oven, or plasma-assisted microwave oven, could be applied.

For fiber reinforced polymer composites, one embodiment relates to a manufacturing method to combine fibers and resin matrix to produce a curable fiber reinforced polymer composition or a prepreg and is subsequently cured to produce a composite article. Employable is a wet method in which fibers are soaked in a bath of the resin matrix dissolved in a solvent such as methyl ethyl ketone or methanol, and withdrawn from the bath to remove solvent.

Another method is hot melt method, where the epoxy resin composition is heated to lower its viscosity, directly applied to the reinforcing fibers to obtain a resin-impregnated prepreg; or alternatively as another method, the epoxy resin composition is coated on a release paper to obtain a thin film. The film is consolidated onto both surfaces of a sheet of reinforcing fibers by heat and pressure.

To produce a composite article from the prepreg, for example, one or more plies are applied onto to a tool surface or mandrel. This process is often referred to as tape-wrapping. Heat and pressure are needed to laminate the plies. The tool is collapsible or removed after cured. Curing methods such as autoclave and vacuum bag in an oven equipped with a vacuum line could be used. One-step cure cycle or multiple-step cure cycle in that each step is performed at a certain temperature for a period of time could be used to reach a cure temperature of about 220° C. or even 180° C. or less. However, other suitable methods such as conductive heating, microwave heating, electron beam heating and similar or the alike, can also be employed. In autoclave method pressure is provided to compact the plies, while vacuum-bag method relies on the vacuum pressure introduced to the bag when the part is cured in an oven. Autoclave method is could be used for high quality composite parts.

Without forming prepregs, the adhesive composition may be directly applied to reinforcing fibers which were conformed onto a tool or mandrel for a desired part's shape, and cured under heat. The methods include, but not limited to, filament-winding, pultrusion molding, resin injection molding and resin transfer molding/resin infusion. A resin transfer molding, resin infusion, resin injection molding, vacuum assisted resin transfer molding or the alike or similar methods could be used.

### Examination of a Reinforced Interphase in a Cured Bonded Structure and Bond Strength

In a mechanical test a bonded structure is loaded to the point of fracture. The nature of the fracture (adhesive fracture, cohesive fracture, substrate fracture or a combination of these) provides information about the quality of the bond and about any potential production errors. For adhesive bonded joints, bond strengths can be determined from a lap shear test, a peel test or wedge test. For fiber reinforced polymer composites, short beam shear test or three point bending (flexure) test is a typical test to document a level of adhesion between the fibers and the adhesive. Note that the aforementioned tests are typical. Modifications of them or other applicable tests to document adhesion depending on the systems of interest and geometries could be used.

Adhesive failure refers to a fracture failure at the interface between the adherend and the adhesive composition, exposing the adherend's surface with little or no adhesive found on the surface. Cohesive failure refers to a fracture failure occurred in the adhesive composition, and the adherend's surface is mainly covered with the adhesive composition. Note that cohesive failure in the adherend may occur, but it is not referred to in the embodiments herein. The coverage could be about 50% or more, or about 70% or more. Note that quantitative documentation of surface coverage, especially in the case of fiber reinforced polymer composites, is not required. Mixed mode failure refers to combination of adhesive failure and cohesive failure. Adhesive failure refers to weak adhesion and cohesive failure is strong adhesion, while mixed mode failure results in adhesion somewhere in between.

For visual inspection a high magnification optical microscope or a scanning electron microscope (SEM) could be used to document the failure modes and location/distribution of an interfacial material. The interfacial material could be found on the surface of the adherend along with the adhesive composition after the bonded structure fails. In such cases, mixed mode failure or cohesive failure of the adhesive composition are possible. Good particle migration refers to about 50% or more coverage of the particle on the adherend surface, no particle migration refers to less than about 5% coverage, and some particle migration refers to about 5-50%.

Several methods are known to one skilled in the art to examine and locate the presence of the interfacial material through thickness. An example is to cut the bonded structure at 90°, 45° or other angles of interest with respected to the adherend's principal direction to obtain a cross section. For fiber reinforced polymer composites, the principle direction could be the fiber's direction. For other bonded structures, any direction can be regarded as the principal direction. The cut cross-section is polished mechanically or by an ion beam such as argon, and examined under any high magnification optical microscope or electron microscopes. SEM is one possible method. Note that in case SEM could not observe the interphase, other available state-of-the-art instruments could be used to document the existing of the interphase and its thickness through other electron scanning method such as TEM, chemical analyses (e.g., X-ray photoelectron spectroscopy (XPS), Time-of-Flight Secondary Ion Mass Spectrometry (ToF-SIMS), infrared (IR) spectroscopy, Raman, the alike or similar) or mechanical properties (e.g., nanoidentation, atomic force microscopy (AFM), the alike or similar).

An interfacial region or an interphase where the interfacial material is concentrated could be observed and documented. The interphase typically measured from the adherend's surface to a definite distance away where the interfacial material is no longer concentrated compared to the surrounding resin-rich areas. Depending on the amount of the cured adhesive found between two adherends or bond line thickness, the interphase could be extending up to 100 micrometers, comprising one or more layers of the interfacial material of one or more different kinds.

For fiber reinforced polymer composites, the bond line thickness depends on a fiber volume. The fiber volume could be between 20-85%, between 30-70%, or between 45-65%. The interphase thickness could be up to about 1 fiber diameter, comprising one or more layers of the interfacial material of one or more different kinds. The thickness could be up to about 1/2 of the fiber diameter.

### EXAMPLES

Next, the embodiments are described in detail by means of the following examples with the following components:

| Component | Product name | Manufacturer | Description |
|---|---|---|---|
| Epoxy | ELM434 | Sumitomo Chemical | Tetra glycidyl diamino diphenyl |
| | | Co., Ltd. | methane with a functionality of 4, |
| | | | having an average EEW of 120 |
| | | | (ELM434) |
| | Epon ™ 825 | Hexion Specialty | Diglycidyl ether of bisphenol A with |
| | | Chemicals, Inc. | a functionality of 2, having an |
| | | | average EEW of 177 (EPON825) |
| | Epiclon 830 | Dainippon Ink and | Diglycidyl ether of bisphenol F with |
| | | Chemicals, Inc. | a functionality of 2, having an |
| | | | average EEW of 177 (EPc830) |
| | Epon ™ 2005 | Hexion Specialty | Diglycidyl ether of bisphenol A with |
| | | Chemicals, Inc. | a functionality of 2, having an |
| | | | average EEW of 1300 (EPON2005) |
| | | Nippon Kayaku | Glycidylaniline with a functionality |
| | | K.K. | of 1 and having an average EEW of |
| | | | 166 (GAN) |
| Migrating | Sumika Excel | Sumitomo Chemical | Polyethersulfone, MW 38,200 (PES1) |
| agent | PES5003P | Co., Ltd. | |
| | VW-10700RP | Solvay | Polyethersulfone, MW 21,000 (PES2) |
| | Ultem 1000P | Sabic | Polyetherimide (PEI) |
| | Vinylec | Chisso Corporation | Polyvinyl formal (PVF) |
| | type K | | |
| Thermoplastic | Grilamid | EMS-Grivory | Polyamide (PA) |
| particle | TR55 | | |
| Curing agent | ARADUR | Huntsman Advanced | 4,4′-diaminodiphenyl sulfone |
| | 9664-1 | Materials | (4,4-DDS) |
| | Aradur | | 3,3′-diaminodiphenyl sulfone |
| | 9719-1 | | (3,3-DDS) |
| | Dyhard | Alz Chem | Dicyandiamide (DICY) |
| | 100S | Trostberg GmbH) | |
| Accelerator | Dyhard | Alz Chem | 3-(3,4-dichlorophenyl)-1,1-dimethyl |
| | UR200 | Trostberg GmbH | urea (UR200) |
| Interfacial | Kane Ace | Kaneka Texas | 25 wt % core-shell rubber (CSR) |
| material | MX416 | Corporation | particles having core composition of |
| | | | polybutadiene (CSR1) in epoxy |
| | Kane Ace | Kaneka Texas | 25 wt % CSR particles having core |
| | MX125 | Corporation | composition polybutadiene and |
| | | | polystyrene (CSR2) in epoxy |
| Carbon fiber | T800SC- | Toray Industries, | 24,000 fibers, tensile strength 5.9 |
| | 24K-10E | Inc. | GPa, tensile modulus 290 GPa, |
| | | | tensile strain 2.0%, type-1 sizing for |
| | | | epoxy resin systems (T800S-10) |
| | T800GC- | Toray Industries, | 24,000 fibers, tensile strength 5.9 |
| | 24K-31E | Inc. | GPa, tensile modulus 290 GPa, |
| | | | tensile strain 2.0%, type-3 sizing for |
| | | | epoxy resin systems (T800G-31). No |
| | | | sizing (T800G-91) |
| | T800GC- | Toray Industries, | 24,000 fibers, tensile strength 5.9 |
| | 24K-51C | Inc. | GPa, tensile modulus 290 GPa, |
| | | | tensile strain 2.0%, type-5 sizing for |
| | | | epoxy, phenolic, polyester, vinyl |
| | | | ester resin systems (T800G-51) |
| | T700GC- | Toray Industries, | 12,000 fibers, tensile strength 4.9 |
| | 12K-31E | Inc. | GPa, tensile modulus 240 GPa, |
| | | | tensile strain 2.0%, type-3 sizing for |
| | | | epoxy resin systems (T700G-31) |
| | T700GC- | Toray Industries, | 12,000 fibers, tensile strength 4.9 |
| | 12K-41C | Inc. | GPa, tensile modulus 240 GPa, |
| | | | tensile strain 2.0%, type-4 sizing for |
| | | | epoxy, phenolic, BMI resin systems |
| | | | (T700G-41) |
| | M40JB- | Toray Industries, | 6,000 fibers, tensile strength 4.4 |
| | 6K-50B | Inc. | GPa, tensile modulus 370 GPa, |
| | | | tensile strain 1.2%, type-5 sizing for |
| | | | epoxy, phenolic, polyester, vinyl |
| | | | ester resin systems (M40J-50) |
| | MX-12K- | Toray Industries, | 12,000 fibers, tensile strength 4.9 |
| | 50C | Inc. | GPa, tensile modulus 370 GPa, |
| | | | tensile strain 1.2%, type-5 sizing for |
| | | | epoxy, phenolic, polyester, vinyl |
| | | | ester resin systems (MX-50) |
| | MX-12K- | Toray Industries, | 12,000 fibers, tensile strength 4.9 |
| | 10E | Inc. | GPa, tensile modulus 370 GPa, |
| | | | tensile strain 1.2%, type-1 sizing for |
| | | | epoxy resin systems (MX-10) |

MX fibers were made using a similar PAN precursor in a similar spinning process as T800S fibers. However, to obtain a higher modulus, a maximum carbonization temperature of 2500° C. was applied. For surface treatment and sizing application, similar processes were utilized.

### Examples 1-2 and Comparative Examples 17-18

Examples 1-2 and Comparative Examples 17-18, where Comparative Examples 17-18 are the controls, demonstrate the effect of the interfacial material CSR1 when it is present with the migrating agent PES 1 in the adhesive composition, and the effect of particle loading. The fiber used was T800S-10.

Appropriate amounts of epoxies, interfacial material CSR1, and migrating agent PES1 in the compositions 1-2 were charged into a mixer preheated at 100° C. After charging, the temperature was increased to 160° C. while the mixture was agitated, and held for 1 hr. After that, the mixture was cooled to 70° C. and 4,4-DDS was charged. The final resin mixture was agitated for 1 hr, then discharged and some were stored in a freezer.

Some of the hot mixture was degassed in a planetary mixer rotating at 15000 rpm for a total of 20 min, and poured into a metal mold with 0.25 in thick Teflon insert. The resin was heated to 180° C. with the ramp rate of 1.7° C./min, allowed to dwell for 2 hr to complete curing, and finally cooled down to room temperature. Resin plates were prepared for testing according to ASTM D-790 for flexural test, and ASTM D-5045 for fracture toughness test. The cured resin T_{g} was determined by dynamic mechanic analysis (DMA) on an Alpha Technologies Model APA 2000 instrument.

To make a prepreg, the hot resin was first casted into a thin film using a knife coater onto a release paper. The film was consolidated onto a bed of fibers on both sides by heat and compaction pressure. A UD prepreg having carbon fiber area weight of about 190 g/m² and resin content of about 35% was obtained. The prepregs were cut and hand laid up with the sequence listed in Table 2 for each type of mechanical test, followed an ASTM procedure. Panels were cured in an autoclave at 180° C. for 2 hr with a ramp rate of 1.7° C./min and a pressure of 0.59 MPa.

The procedure for resin mixing was repeated for the controls of compositions 17-18. In these cases, either only the migrating agent PES1 or only the interfacial material CSR1 was present in the adhesive composition. A prepreg was made for the composition 17 and mechanical tests were performed for the composite. However, due to low viscosity of the resin of composition 18, a prepreg was made by directly applying the resin onto fibers without first casting the resin on the release paper and cured to observe adhesive failure mode only.

Compared the resin composition 18 to 17, the presence of CSR1 increased the resin's fracture toughness K_{IC}, yet its flexural modulus was decreased. Yet, for both cases, none of the interfacial material was found on the fiber's surface under SEM observation of the fractured specimens, i.e., adhesive failure occurred. This indicates that weak adhesion between the resin and fibers.

Surprisingly, when both CSRI and PES1 were present in the Compositions 1-2, a substantial amount of CSR1 material and cured resin were found to form a layer on a surface of the fibers as the 0-degree fractured surfaces with respect to the fiber direction were examined. This concludes a cohesive failure in the resin has occurred. The 90 deg cross-sections showed that CSRI material was concentrated around the fibers up to a distance of about 0.1 to about 0.5 um as the amount of CSR1 particle increased from 2.5 to 5 phr, respectively. Tensile strength for these cases increased about 10% and G_{IC} increased about 1.5 folds, compared to the control Comparative Examples 17-18. Simultaneous increase in both G_{IC} and tensile strength has not seen in other conventional systems up to date. The improvement in tensile strength might be explained with a multilayered interphase or a reinforced interphase where a thin inner layer formed by the resin and the sizing material on the fiber as seen in the conventional interphase is protected by much thicker outer toughened layers by CSR1 material, allowing the crack energy at the fibers' broken ends to be dissipated within this interphase. Yet, as the resin's modulus was decreased with this soft interfacial material, compressive strength decreased. ILSS, on the other hand, remained unchanged as expected due to counter effect between resin's modulus reduction and adhesion improvement. Reduction of the interfacial material loading could minimize the penalty in compressive properties and perhaps increase ILSS as shown in Examples 1-2.

### Examples 1, 3 and Comparative Examples 17, 19

In these examples, the effect of loading ratio between PES1 was explored. Resins, prepregs and composite mechanical tests were performed as in Examples 1-2. The controls arc Comparative Examples 17, 19.

Surprisingly, though good particle migration was achieved, higher amount of PES1 just improved TS at room temperature marginally while G_{IC} was improved substantially. Yet, a substantial increased in TS at −75 F was found.

### Examples 4-6 and Comparative Examples 20-22

Resins, prepreg and composite mechanical tests were performed in procedures as in Examples 1-2. The controls are Comparative Examples 20-22.

Note that for these examples, since a type-5 sizing finish was used on three fibers T800G-51, MX-50 and M40J-50 with different surface morphologies such that T800G-51 and MX-50 have smoother surface and different surface treatments such that T800G-51 is treated with a base, while the other two are treated with an acid, presumably surface energy for each fiber is different. For both T800G-51 and MX-50 systems, good particle migration was found while some particle migration (little to none particle migration) was found in M40J-50 system. Due to a little of particle migration was found in the M40J-50 system, no improvements in both TS was found while for the other cases a good improvement in TS was observed. This case implies the importance of surface energy on the formation of the reinforced interphase, which in turn affects TS. It was expected that if surface energy of M40J-50 was modified similar to those of MX-50, good particle migration would have been resulted and TS improvement would have been achieved.

### Example 7 and Comparative Example 23

Resins, prepreg and composite mechanical tests were performed in procedures as in Examples 1-2. The control is Comparative Example 22. The fiber used was MX-10 to reconfirm a possibility to create a reinforced interphase with type-1 sized carbon fiber.

Good particle migration was found in Example 7 and correspondingly a good improvement in both TS and G_{IC}.

### Examples 8-9 and Comparative Examples 24-26

Resins, prepreg and composite mechanical tests were performed in procedures as in Examples 1-2. The controls are Comparative Examples 24-26. These examples examined the creation of a reinforced interphase by changing fiber surfaces and changing PES 1 to PES2 having a lower molecular weight and CSR1 to CSR2. Also, effect of particle loading in T800G-31 systems were documented.

Good particle migration and similar trends to those in Examples 1-2 were observed with T800G-31 systems. Interestingly enough both TS at room temperature and −75 F were substantially increased in Example 8. TS at −75 F in Example 9 was also expected to increase though it was not measured.

Yet, no particle migration was found when the fiber surface changed from T800G-31 to T800G-91 and MX-50. These cases reconfirmed the importance of a suitable surface energy for particle migration. For these cases, no mechanical properties were measured.

### Example 10 and Comparative Example 27

Resins, prepregs and mechanical tests were performed in procedures as in Examples 1-2. The control is Comparative Example 27. This example studied the effect of interlayer toughener in addition to the formation of a reinforced interphase in T800G-31 system.

Good particle migration was found and hence TS was improved. Since interlayer tougheners were used, CAI and GIIC were improved significantly.

### Example 11 and Comparative Example 28

Resins, prepregs and mechanical tests were performed in procedures as in Examples 1-2. The control is Comparative Example 28. This example examined T700G-41, having a type-4 sizing which probably induces a different surface energy from previous examples.

Good particle migration was found and TS was improved in this example, similar trends to other cases having good particle migration.

### Examples 12- 15 and Comparative Examples 29-32

Resins, prepregs and mechanical tests were performed in procedures as in Examples 1-2. The controls are Comparative Examples 29- 32 for Examples 12-15, respectively. These cases examined the formation of a reinforced interphase when changing EPON825 to GAN, 4,4-DDS to 3,3-DDS, and PES1 or PES2 to PEI and PVF. T800G-31 was used for all cases as its surface energy would promote good particle migration.

Good particle migration was found and hence TS was improved in these examples, similar trends to other cases having good particle migration.

### Example 16 and Comparative Example 33

The control is Comparative Example 33. This case examined the formation of a reinforced interphase as an accelerator was used. T800G-31 was used. Resins, prepregs and mechanical tests were performed in procedures as in Examples 1-2.

Good particle migration was found and hence TS was improved in these examples, similar trends to other cases having good particle migration.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. The numerical ranges disclosed inherently support any range within the disclosed numerical ranges though a precise range limitation is not stated verbatim in the specification because this invention can be practiced throughout the disclosed numerical ranges. Finally, the entire disclosure of the patents and publications referred in this application are hereby incorporated herein by reference.

TABLE 1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Resin | Epoxy | ELM434 | 60 | 60 | 50 | 60 | 60 | 60 | 60 | 50 | 50 | 60 | 60 |
| (phr) | | EPON825 | 30 | 30 | 30 | 30 | 30 | 30 | 30 | 30 | 30 | 30 | 30 |
| | | EPc830 | 10 | 10 | 20 | 10 | 10 | 10 | 10 | 20 | 20 | 10 | 10 |
| | | EPON2005 | 0 | 0 | 0 | 0 | 0 | 0 | 0 | 0 | 0 | 0 | 0 |
| | | GAN | 0 | 0 | 0 | 0 | 0 | 0 | 0 | 0 | 0 | 0 | 0 |
| | Curing agent | 4,4-DDS | 45 | 45 | 43 | 45 | 45 | 45 | 45 | 43 | 43 | 45 | 45 |
| | | 3,3-DDS | 0 | 0 | 0 | 0 | 0 | 0 | 0 | 0 | 0 | 0 | 0 |
| | | DICY | 0 | 0 | 0 | 0 | 0 | 0 | 0 | 0 | 0 | 0 | 0 |
| | Accelerator | UR200 | 0 | 0 | 0 | 0 | 0 | 0 | 0 | 0 | 0 | 0 | 0 |
| | Interfacial | CSR1 | 2.5 | 5 | 2.5 | 5 | 10 | 5 | 15 | 0 | 0 | 5 | 5 |
| | material | CSR2 | 0 | 0 | 0 | 0 | 0 | 0 | 0 | 2.5 | 5 | 0 | 0 |
| | Migrating agent | PES1 | 6 | 6 | 12 | 6 | 6 | 6 | 6 | 0 | 0 | 12 | 6 |
| | | PES2 | 0 | 0 | 0 | 0 | 0 | 0 | 0 | 15 | 15 | 0 | 0 |
| | | PEI | 0 | 0 | 0 | 0 | 0 | 0 | 0 | 0 | 0 | 0 | 0 |
| | | PVF | 0 | 0 | 0 | 0 | 0 | 0 | 0 | 0 | 0 | 0 | 0 |
| | Optional | PA | 0 | 0 | 0 | 0 | 0 | 0 | 0 | 0 | 0 | 30 | 0 |
| Fiber | Type-1 sizing | T800S-10E | 100 | 100 | 100 | 0 | 0 | 0 | 0 | 0 | 0 | 0 | 0 |
| (wt %) | | MX-10E | 0 | 0 | 0 | 0 | 0 | 0 | 100 | 0 | 0 | 0 | 0 |
| | Type-3 sizing | T800G-31E | 0 | 0 | 0 | 0 | 0 | 0 | 0 | 100 | 100 | 100 | 0 |
| | | T700G-31E | 0 | 0 | 0 | 0 | 0 | 0 | 0 | 0 | 0 | 0 | 0 |
| | Type-4 sizing | T700G-41C | 0 | 0 | 0 | 0 | 0 | 0 | 0 | 0 | 0 | 0 | 100 |
| | Type-5 sizing | T800G-51C | 0 | 0 | 0 | 100 | 0 | 0 | 0 | 0 | 0 | 0 | 0 |
| | | MX-50C | 0 | 0 | 0 | 0 | 100 | 0 | 0 | 0 | 0 | 0 | 0 |
| | | M40J-50B | 0 | 0 | 0 | 0 | 0 | 100 | 0 | 0 | 0 | 0 | 0 |
| | No sizing | T800G-91 | 0 | 0 | 0 | 0 | 0 | 0 | 0 | 0 | 0 | 0 | 0 |
| Prepreg | Prepreg area weight (g/m²) | | — | 317 | — | 296 | 290 | — | 295 | 304 | 309 | — | 311 |
| | Resin content, wt % | | 32 | — | 34 | — | — | 35 | — | — | — | 37 | — |
| | Fiber area weight, g/m² | | 199 | 190 | 198 | 190 | 190 | 190 | 190 | 190 | 190 | 195 | 190 |
| | | | Example | | | | | Comparative Example | | | | | |
| | | | 12 | 13 | 14 | 15 | 16 | 17 | 18 | 19 | 20 | 21 | 22 |
| Resin | Epoxy | ELM434 | 60 | 60 | 50 | 60 | 10 | 60 | 60 | 50 | 60 | 60 | 60 |
| (phr) | | EPON825 | 20 | 20 | 30 | 30 | 60 | 30 | 30 | 30 | 30 | 30 | 30 |
| | | EPc830 | 10 | 0 | 20 | 10 | 0 | 10 | 10 | 20 | 10 | 10 | 10 |
| | | EPON2005 | 0 | 0 | 0 | 0 | 30 | 0 | 0 | 0 | 0 | 0 | 0 |
| | | GAN | 20 | 20 | 0 | 0 | 0 | 0 | 0 | 0 | 0 | 0 | 0 |
| | Curing | 4,4-DDS | 45 | 0 | 43 | 45 | 0 | 45 | 45 | 43 | 45 | 45 | 45 |
| | agent | 3,3-DDS | 0 | 45 | 0 | 0 | 0 | 0 | 0 | 0 | 0 | 0 | 0 |
| | | DICY | 0 | 0 | 0 | 0 | 3.6 | 0 | 0 | 0 | 0 | 0 | 0 |
| | Accelerator | UR200 | 0 | 0 | 0 | 0 | 3.4 | 0 | 0 | 0 | 0 | 0 | 0 |
| | Interfacial | CSR1 | 0 | 5 | 5 | 5 | 0 | 0 | 2.5 | 0 | 0 | 0 | 0 |
| | material | CSR2 | 2.5 | 0 | 0 | 0 | 0 | 0 | 0 | 0 | 0 | 0 | 0 |
| | Migrating agent | PES1 | 6 | 6 | 0 | 0 | 0 | 6 | 0 | 12 | 6 | 6 | 6 |
| | | PES2 | 0 | 0 | 0 | 0 | 0 | 0 | 0 | 0 | 0 | 0 | 0 |
| | | PEI | 0 | 0 | 9 | 0 | 6 | 0 | 0 | 0 | 0 | 0 | 0 |
| | | PVF | 0 | 0 | 0 | 9 | 0 | 0 | 0 | 0 | 0 | 0 | 0 |
| | Optional | PA | 0 | 0 | 0 | 0 | 0 | 0 | 0 | 0 | 0 | 0 | 0 |
| Fiber | Type-1 sizing | T800S-10E | 0 | 0 | 0 | 0 | 0 | 100 | 100 | 100 | 0 | 0 | 0 |
| (wt %) | | MX-10E | 0 | 0 | 0 | 0 | 0 | 0 | 0 | 0 | 0 | 0 | 0 |
| | Type-3 sizing | T800G-31E | 100 | 100 | 100 | 100 | 0 | 0 | 0 | 0 | 0 | 0 | 0 |
| | | T700G-31E | 0 | 0 | 0 | 0 | 100 | 0 | 0 | 0 | 0 | 0 | 0 |
| | Type-4 sizing | T700G-41C | 0 | 0 | 0 | 0 | 0 | 0 | 0 | 0 | 0 | 0 | 0 |
| | Type-5 sizing | T800G-51C | 0 | 0 | 0 | 0 | 0 | 0 | 0 | 0 | 100 | 0 | 0 |
| | | MX-50C | 0 | 0 | 0 | 0 | 0 | 0 | 0 | 0 | 0 | 100 | 0 |
| | | M40J-50B | 0 | 0 | 0 | 0 | 0 | 0 | 0 | 0 | 0 | 0 | 100 |
| | No sizing | T800G-91 | 0 | 0 | 0 | 0 | 0 | 0 | 0 | 0 | 0 | 0 | 0 |
| Prepreg | Prepreg area weight (g/m²) | | — | — | — | — | — | — | — | — | 296 | 292 | — |
| | Resin content, wt % | | 35 | 35 | 35 | 34 | 35 | 32 | 32 | 34 | — | — | 35 |
| | Fiber area weight, g/m² | | 191 | 190 | 190 | 190 | 125 | 204 | 204 | 196 | 190 | 190 | 190 |
| | | | Comparative Example | | | | | | | | | | |
| | | | 23 | 24 | 25 | 26 | 27 | 28 | 29 | 30 | 31 | 32 | 33 |
| Resin | Epoxy | ELM434 | 60 | 50 | 60 | 60 | 60 | 60 | 60 | 60 | 50 | 60 | 10 |
| (phr) | | EPON825 | 30 | 30 | 30 | 30 | 30 | 30 | 20 | 20 | 30 | 30 | 60 |
| | | EPc830 | 10 | 20 | 10 | 10 | 10 | 10 | 0 | 0 | 20 | 10 | 0 |
| | | EPON2005 | 0 | 0 | 0 | 0 | 0 | 0 | 0 | 0 | 0 | 0 | 30 |
| | | GAN | 0 | 0 | 0 | 0 | 0 | 0 | 20 | 20 | 0 | 0 | 0 |
| | Curing | 4,4-DDS | 45 | 43 | 45 | 45 | 45 | 45 | 45 | 0 | 43 | 45 | 0 |
| | agent | 3,3-DDS | 0 | 0 | 0 | 0 | 0 | 0 | 0 | 45 | 0 | 0 | 0 |
| | | DICY | 0 | 0 | 0 | 0 | 0 | 0 | 0 | 0 | 0 | 0 | 3.6 |
| | Accelerator | UR200 | 0 | 0 | 0 | 0 | 0 | 0 | 0 | 0 | 0 | 0 | 3.4 |
| | Interfacial | CSR1 | 0 | 0 | 2.5 | 5 | 0 | 0 | 0 | 0 | 0 | 0 | 0 |
| | material | CSR2 | 0 | 0 | 0 | 0 | 0 | 0 | 0 | 0 | 0 | 0 | 0 |
| | Migrating agent | PES1 | 6 | 0 | 0 | 0 | 12 | 6 | 6 | 6 | 0 | 0 | 0 |
| | | PES2 | 0 | 15 | 15 | 15 | 0 | 0 | 0 | 0 | 0 | 0 | 0 |
| | | PEI | 0 | 0 | 0 | 0 | 0 | 0 | 0 | 0 | 9 | 0 | 6 |
| | | PVF | 0 | 0 | 0 | 0 | 0 | 0 | 0 | 0 | 0 | 9 | 0 |
| | Optional | PA | 0 | 0 | 0 | 0 | 30 | 0 | 0 | 0 | 0 | 0 | 0 |
| Fiber | Type-1 sizing | T800S-10E | 0 | 0 | 0 | 0 | 0 | 0 | 0 | 0 | 0 | 0 | 0 |
| (wt %) | | MX-10E | 100 | 0 | 0 | 0 | 0 | 0 | 0 | 0 | 0 | 0 | 0 |
| | Type-3 sizing | T800G-31E | 0 | 100 | 0 | 0 | 100 | 0 | 100 | 100 | 100 | 100 | 0 |
| | | T700G-31E | 0 | 0 | 0 | 0 | 0 | 0 | 0 | 0 | 0 | 0 | 100 |
| | Type-4 sizing | T700G-41C | 0 | 0 | 0 | 0 | 0 | 100 | 0 | 0 | 0 | 0 | 0 |
| | Type-5 sizing | T800G-51C | 0 | 0 | 0 | 0 | 0 | 0 | 0 | 0 | 0 | 0 | 0 |
| | | MX-50C | 0 | 0 | 100 | 0 | 0 | 0 | 0 | 0 | 0 | 0 | 0 |
| | | M40J-50B | 0 | 0 | 0 | 0 | 0 | 0 | 0 | 0 | 0 | 0 | 0 |
| | No sizing | T800G-91 | 0 | 0 | 0 | 100 | 0 | 0 | 0 | 0 | 0 | 0 | 0 |

| | | | | | | | | | | | | |
|---|---|---|---|---|---|---|---|---|---|---|---|---|
| Prepreg | Prepreg area weight (g/m²) | 296 | 299 | — | — | — | 302 | — | — | — | — | 0 |
| | Resin content, wt % | — | — | 37 | 37 | 34 | — | 34 | 34 | 34 | 34 | 32 |
| | Fiber area weight, g/m² | 190 | 190 | 200 | 200 | 196 | 190 | 188 | 190 | 191 | 190 | 125 |

TABLE 2

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Cured | Flexure | Modulus, GPa | 3.1 | 3.0 | 3.1 | 3.0 | 2.8 | 3.0 | 2.7 | 3.1 | 3.0 | 3.0 | 3.0 |
| resin | Fracture | K_{IC}, MPa-m^{1/2} | 0.7 | 0.8 | 0.7 | 0.8 | 1.0 | 0.8 | 1.2 | 0.7 | 0.8 | 0.8 | 0.8 |
| | toughness | | | | | | | | | | | | |
| | Heat | Tg (° C., Alpha) | 208 | 208 | 205 | 206 | 202 | 205 | 207 | 205 | 204 | 205 | 206 |
| | Resistance | | | | | | | | | | | | |
| Interphase's properties | | Migration (G: | G | G | G | G | G | S | G | G | G | G | G |
| | | Good, S: Some, | | | | | | | | | | | |
| | | N: No) | | | | | | | | | | | |
| | | Interphase | 0.1 | 0.1-0.5 | 0.1 | 0.1-0.5 | 0.1-1 | 0.1-0.5 | 0.1-1 | 0.1 | 0.1-0.5 | 0.1-0.5 | 0.1-0.5 |
| | | thickness, | | | | | | | | | | | |
| | | 90°-deg | | | | | | | | | | | |
| | | cross section | | | | | | | | | | | |
| | | (um) | | | | | | | | | | | |
| CFRP | Tension* | Strength @ | 490 | 501 | 425 | 418 | 305 | 313 | 250 | 464 | 503 | 455 | 415 |
| | | RTD (ksi) | | | | | | | | | | | |
| | | Modulus RTD | 23.9 | 23.9 | 22.7 | 21.6 | 28.9 | 30.2 | 29.8 | 23.3 | 23.1 | 23.3 | 19.6 |
| | | (Msi) | | | | | | | | | | | |
| | | Strength @ | — | 505 | 480 | — | — | — | — | 454 | — | 440 | — |
| | | −75 F. (ksi) | | | | | | | | | | | |
| | Fracture | G_{IC} (lb · in/in²) | 4.2 | 5.5 | 5.2 | 4.0 | 1.4 | 1.4 | 2.1 | 3.4 | 4.5 | 3.5 | 3.4 |
| | toughness | G_{IIC} (lb · in/in²) | 4.7 | 4.6 | 4.4 | 4.4 | 3.6 | 3.0 | 3.4 | 4.6 | 4.5 | 12.0 | 3.9 |
| | Adhesion | Interlaminar | 15.0 | 14.7 | 15.5 | 14.7 | 15.3 | 14.9 | 14.8 | 15.0 | 14.9 | — | 14.1 |
| | | shear strength | | | | | | | | | | | |
| | | (ksi) | | | | | | | | | | | |
| | Compression* | Ultimate | 210 | 190 | 210 | 191 | 175 | 175 | 166 | 200 | 185 | 195 | 182 |
| | | strength (ksi) | | | | | | | | | | | |

| | | | Example | | | | | Comparative Example | | | | | |
|---|---|---|---|---|---|---|---|---|---|---|---|---|---|
| | | | 12 | 13 | 14 | 15 | 16 | 17 | 18 | 19 | 20 | 21 | 22 |
| Cured | Flexure | Modulus, GPa | 3.4 | 3.8 | 3.1 | 3.1 | — | 3.2 | 3.1 | 3.2 | 3.2 | 3.2 | 3.2 |
| resin | Fracture | K_{IC}, MPa-m^{1/2} | 0.7 | 0.6 | 0.7 | 0.7 | — | 0.6 | 0.7 | 0.6 | 0.6 | 0.6 | 0.6 |
| | toughness | | | | | | | | | | | | |
| | Heat Resistance | Tg (° C., Alpha) | 202 | 203 | 198 | 203 | — | 208 | 208 | 208 | 208 | 208 | 208 |
| Interphase's properties | | Migration | G | G | G | G | G | — | N | — | — | — | — |
| | | (G: Good, S: Some, | | | | | | | | | | | |
| | | N: No) | | | | | | | | | | | |
| | | Interphase | 0.1 | 0.1-0.5 | 0.1-0.5 | 0.1-0.5 | 0.1-0.5 | — | — | — | — | — | — |
| | | thickness, | | | | | | | | | | | |
| | | 90°-deg | | | | | | | | | | | |
| | | cross section | | | | | | | | | | | |
| | | (um) | | | | | | | | | | | |
| CFRP | Tension* | Strength @ | 444 | 450 | 460 | 445 | 410 | 438 | — | 400 | 360 | 270 | 315 |
| | | RTD (ksi) | | | | | | | | | | | |
| | | Modulus RTD | 22.0 | 21.2 | 22.2 | 21.7 | 20.1 | 23.6 | — | 22.4 | 22.2 | 29.4 | 30.2 |
| | | (Msi) | | | | | | | | | | | |
| | | Strength @ | 399 | 380 | — | — | — | — | — | 416 | — | — | — |
| | | −75 F. (ksi) | | | | | | | | | | | |
| | Fracture | G_{IC} (lb · in/in²) | 1.7 | 2.5 | 3.5 | 3.7 | 3.5 | 3.0 | — | 3.2 | 2.0 | 0.8 | 1.2 |
| | toughness | G_{IIC} (lb · in/in²) | 4.3 | — | — | — | 6.7 | 4.6 | — | 4.9 | 4.5 | 3.9 | 3.0 |
| | Adhesion | Interlaminar | — | — | — | — | — | 14.8 | — | 15.8 | 15.2 | 16.0 | 14.6 |
| | | shear strength | | | | | | | | | | | |
| | | (ksi) | | | | | | | | | | | |
| | Compression* | Ultimate | 225 | 237 | 193 | 189 | 200 | 223 | — | 239 | 215 | 179 | 186 |
| | | strength (ksi) | | | | | | | | | | | |

| | | | Comparative Example | | | | | | | | | | |
|---|---|---|---|---|---|---|---|---|---|---|---|---|---|
| | | | 23 | 24 | 25 | 26 | 27 | 28 | 29 | 30 | 31 | 32 | 33 |
| Cured resin | Flexure | Modulus, GPa | 3.2 | 3.2 | 3.1 | 3.0 | — | 3.2 | 3.5 | 3.9 | 3.2 | 3.2 | — |
| | Fracture toughness | K_{IC}, MPa-m^{1/2} | 0.6 | 0.6 | 0.7 | 0.7 | — | 0.6 | 0.5 | 0.5 | 0.6 | 0.6 | — |
| | Heat Resistance | Tg (° C., Alpha) | 208 | 208 | 208 | 208 | — | 208 | 203 | 200 | 200 | 202 | — |
| Interphase's properties | | Migration (G: Good, | — | — | N | N | — | — | — | — | — | — | — |
| | | S: Some, N: No) | | | | | | | | | | | |
| | | Interphase thickness, | — | — | — | — | — | — | — | — | — | — | — |
| | | 90°-deg cross section | | | | | | | | | | | |
| | | (um) | | | | | | | | | | | |
| CFRP | Tension* | Strength @ | 220 | 405 | — | — | 410 | 355 | 400 | 450 | 420 | 400 | 360 |
| | | RTD (ksi) | | | | | | | | | | | |
| | | Modulus RTD | 29.8 | 22.9 | — | — | 23.0 | 19.5 | 22.0 | 21.2 | 22.0 | 21.2 | 20.6 |
| | | (Msi) | | | | | | | | | | | |
| | | Strength @ | — | 301 | — | — | 310 | — | 339 | 330 | — | — | — |
| | | −75 F. (ksi) | | | | | | | | | | | |
| | Fracture toughness | G_{IC} (lb · in/in²) | 1.2 | 1.6 | — | — | 1.8 | 1.6 | 1.1 | 1.8 | 1.8 | 2.0 | 1.3 |
| | | G_{IIC} (lb · in/in²) | 3.7 | 4.6 | — | — | 11.0 | 4.1 | 4.3 | — | — | — | 7.0 |
| | Adhesion | Interlaminar | 15.3 | 16.9 | — | — | — | 14.5 | — | — | — | — | — |
| | | shear strength | | | | | | | | | | | |
| | | (ksi) | | | | | | | | | | | |
| | Compression* | Ultimate strength | 181 | 228 | — | — | 220 | 209 | 248 | 260 | 218 | 222 | 230 |
| | | (ksi) | | | | | | | | | | | |

*normalized to Vf = 60%

TABLE 3

| | | | Ply Lay-up | |
|---|---|---|---|---|
| | | Panel Size | Configu- | Test |
| Test Panel | Test method | (mm × mm) | ration | Condition |
| 0 deg-Tensile | ASTM D 3039 | 300 × 300 | (0)₆ | RTD |
| Compression | ASTM D 695/ | 300 × 300 | (0)₆ | RTD |
| strength | ASTM D 3410 | | | |
| ILSS | ASTM D-2344 | 300 × 300 | (0)₁₂ | RTD |
| DCB (for G_{IC}) | ASTM D 5528 | 350 × 300 | (0)₂₀ | RTD |
| ENF (for G_{IIC}) | JIS K 7086* | 350 × 300 | (0)₂₀ | RTD |

*Japanese Industrial Standard Test Procedure

1. A structure comprising at least an adherend and an adhesive composition, wherein the adhesive composition comprises at least a thermosetting resin, a curing agent, and an interfacial material, wherein the adherend is suitable for concentrating the interfacial material in an interfacial region between the adherend and the adhesive composition, wherein the interfacial region comprises the interfacial material.

2. The structure of claim 1, wherein the interfacial material is concentrated in-situ in the interfacial region during curing of the thermosetting resin such that the interfacial material has a gradient in concentration in the interfacial region, wherein the interfacial material has a higher concentration in a vicinity of the adherend than further away from the adherend.

3. The structure of claim 1, wherein the adhesive composition further comprises an accelerator.

4. The structure of claim 1, wherein the adhesive composition further comprises a toughening agent, a filler or a combination thereof.

5. The structure of claim 1, wherein the adherend comprises a reinforcing fiber, a carbonaceous substrate, a metal substrate, a metal alloy substrate, a coated metal substrate, an alloy substrate, a wood substrate, an oxide substrate, a plastic substrate, a composite substrate, or a combination thereof.

6. A fiber reinforced polymer composition comprising a reinforcing fiber and an adhesive composition, wherein the adhesive composition comprises at least a thermosetting resin, a curing agent, and an interfacial material, wherein the reinforcing fiber is suitable for concentrating the interfacial material in an interfacial region between the reinforcing fiber and the adhesive composition, wherein the interfacial region comprises the interfacial material.

7. The fiber reinforced polymer composition of claim 6, wherein the interfacial material is concentrated in-situ in the interfacial region during curing of the thermosetting resin such that the interfacial material has a gradient in concentration in the interfacial region, wherein the interfacial material has a higher concentration in a vicinity of the reinforcing fiber than further away from the adherend.

8. The fiber reinforced polymer composition of claim 7, wherein the resin composition further comprises a migrating agent.

9. The fiber reinforced polymer composition of claim 8, further comprises an accelerator.

10. The fiber reinforced polymer composition of claim 8, further comprises a toughening agent, a filler or combinations thereof.

11. The fiber reinforced polymer composition of claim 8, further comprises a thermoplastic particle having a particle size of no more than about 100 μm, wherein after the adhesive composition is cured, the thermoplastic particle is localized outside a fiber bed comprising plurality of the reinforcing fibers.

12. The fiber reinforced polymer composition of claim 8, wherein the interfacial material comprises a polymer, a copolymer, a block copolymer, a branched polymer, a hyperbranched polymer, a dendrimer and the alike, a core-shell rubber particle, a hard core-soft shell particle, a soft core-hard shell particle, an inorganic material, a metal, an oxide, a carbonaceous material, an organic-inorganic hybrid material, a polymer grafted inorganic material, an organofunctionalized inorganic material, a polymer grafted carbonaceous material, an organofunctionalized carbonaceous material or a combination thereof.

13. The fiber reinforced polymer composition of claim 8, wherein the interfacial material comprises an a rubbery polymer, a rubbery copolymer, a block copolymer, a core-shell rubber particle, a core-shell particle, or a combination thereof

14. The fiber reinforced polymer composition of claim 8, wherein the interfacial material comprises a core-shell particle.

15. The fiber reinforced polymer composition of claim 8, wherein an amount of the interfacial material is between about 0.5 to about 25 weight parts per 100 weight parts of the thermosetting resin.

16. The fiber reinforced polymer composition of claim 8, wherein the migrating agent comprises a polymer, a thermoplastic resin, a thermosetting resin, or a combination thereof.

17. The fiber reinforced polymer composition of claim 16, wherein the thermoplastic resin comprises a polyvinyl formal, a polyamide, a polycarbonate, a polyacetal, a polyvinylacetal, a polyphenyleneoxide, a polyphenylenesulfide, a polyarylate, a polyester, a polyamideimide, a polyimide, a polyetherimide, a polyimide having phenyltrimethylindane structure, a polysulfone, a polyethersulfone, a polyetherketone, a polyetheretherketone, a polyaramid, a polyethernitrile, a polybenzimidazole, a derivative thereof, or a combination thereof.

18. The fiber reinforced polymer composition of claim 16, wherein the thermoplastic resin comprises a polyvinyl formal, a polyetherimide, a polyethersulfone or a combination thereof.

19. The fiber reinforced polymer composition of claim 8, wherein an amount of the migrating agent is between about 1 to about 30 weight parts per 100 weight parts of the thermosetting resin.

20. The fiber reinforced polymer composition of claim 8, wherein a ratio of the migrating agent to the interfacial material is about 0.1 to about 30, and wherein the interfacial material comprises a core-shell particle and the migrating agent comprises a polyethersulfone, polyetherimide, polyvinyl formal, or combination thereof.

21. A prepreg comprising a fiber reinforced polymer composition of claim 8.

22. A method of manufacturing a composite article comprising obtaining the fiber reinforced polymer composition of claim 8, and curing the fiber reinforced polymer composition.

23. A reinforced interphase comprising an interfacial region between a reinforcing fiber and an adhesive composition, wherein the interfacial region comprises an interfacial material and has at least a distinctly radial arrangement of the interfacial material with a higher concentration of the interfacial material in a vicinity of the reinforcing fiber than that in the adhesive composition, wherein the interfacial region has an averaged thickness of about 10-1000 nm and a coefficient of variation of less than about 50% of the averaged thickness.

24. A method comprising applying the adhesive composition of claim 1 to a surface of the adherend of claim 1, and curing the adhesive composition to form an adhesive bond, wherein the interfacial material is concentrated in-situ in the interfacial region during curing of the thermosetting resin such that the interfacial material has a gradient in concentration in the interfacial region, wherein the interfacial material has a higher concentration in a vicinity of the adherend than further away from the adherend.
